(19) United States
(12) Patent Application Publication
(10) Pub. No.: US 2019/0021228 A1
(43) Pub. Date: Jan. 24, 2019

(54) SYSTEM FOR COLLECTING AND TRANSPORTING FRUIT OR THE LIKE FROM HILLSIDES OR THE LIKE

(71) Applicant: MIRANDA NARANJO,

(72) Inventor: MIRANDA Oscar Iván NARANJO, Santiago (CL)

(21) Appl. No.: 16/081,935

(22) PCT Filed: Mar. 2, 2016
(86) PCT No.: PCT/CL2016/000009

§ 371 Date: Sep. 3, 2018

(51) Int. Cl. A01D 46/24; B65G 11/02; B65G 11/20

(52) U.S. Cl. CPC A01D 46/24; B65G 11/20; B65G 11/02

(57) ABSTRACT

System for the collection and transport of fruits, from slopes or slopes of hills or the like, is conformed with a tubular body (1) of PVC, which is anchored to the slope of the hill (2) being detachable, light and portable, characterized in that the straight tubular body (1) is provided with openings (3) each a certain number of meters, so as to introduce into said openings (3), containers with fruit (4), which are provided with projections (5), said openings are arranged so as to correspond to the rows of fruit trees; at the lower end of said tubular body (1), a further corrugated tubular retention body (7) of containers (4) and arranged in a curved, non-collapsible manner is fitted by means of a quick coupling system (6), which makes it possible to reduce the speed of the fruit containers (4), those that go inside the tubular body (1) transporting the fruit inside.

### RELATIONSHIP TO OTHER APPLICATIONS

None

### FIELD OF THE INVENTION

The present invention relates to fruit picking and collection

### BACKGROUND AND SCOPE OF THE INVENTION

The invention deals with a system for the collection and transport of fruits, from slopes or slopes of hills or the like, more specifically, it refers to a harvesting system and then transporting to the flat land the fruit that is cultivated in terrains of hills or hills with steep slopes, which presents improved means, which make transport and quantitative monitoring of the harvest more safe and efficient, avoiding accident hazards and falls of personnel during harvesting.

Frosts are one of the main risks of fruit growing. As a way to avoid them, the plantation of fruit orchards has been moved from flat irrigation lands to steeper slopes. These lands of steep slopes have two great advantages:

Frosts do not affect them since the denser frozen air accumulates in the lower sections of the land, and the hill terrain is of lesser value than the land with less slope. On the other hand, they have the disadvantage that the plantation is established in the direction perpendicular to the contour lines, in order to be able to quickly evacuate the rainwater. In addition, roads must be built every 50-60 m in the direction of the contour lines. of the harvest and the management of the plantation particularly for the application of chemical products and detergents, with the consequent loss of land for trees.

Drip irrigation partially solved the demand for planting, but the steepness of these slopes complicate the harvest, increasing costs and accidents.

To solve the existing problem, due to the slope degree of the hill or slope, a harvest and transport system has been created that avoids accidents, does not deteriorate said fruits and facilitates harvesting, avoiding the use of tractors and colossus, so there is no need for intermediate roads between the trees, increasing the useful area of the garden, does not interfere with irrigation, decreases the accident rate because the staff works laterally, on the level curve avoiding falls and allowing a more safe and efficient management of the plantation.

With regard to the state of the art, we can cite the invention CN204146052 the utility model describes a fruit collector, which comprises a telescopic rod (1), a blade or blades of scissors (2) cutting the fruits, a support of a bag (9) and a transport bag of elasticized fruit (7); the upper ends of the scissors blades (2) (left and right) are articulated and fixed to the bag support (9); a spring (4) which is arranged between the two scissors blades (2), a traction cable (5) which is fixed on the upper end with blades or cuffs of the scissors (2), respectively and by the lower end to the telescopic rod (1). The elasticized fruit transport bag (7) is thinner in the middle part, and in the bottom (7) is provided with an elastic closing cord (8). The fruit collector can effectively save the fruit, improve the quality of the fruit and reduce the risks security and is simple structure, low cost, easy to operate, high efficiency and long service life.

Another patent of invention is CLN°43.290, which describes a portable transport system used in harvesting fruits on slopes, comprising an elongated body consisting of a PVC pipe, quick coupling, inside which multiple containers slide by gravity where the fruit is deposited, those that are subject to each other, inside the pipeline by a cable.

Another invention is the patent ES208027, which refers to a collection hopper for olives and other fruits, characterized in that it consists of two hopper bodies of suitable tubular structure, each of which comprises a receiving upper mouthpiece in the form of a semicircular crown, although, the inner semicircumferential edge adopts a certain convergent inclination with respect to a lower circular embouchure of discharge, radiating from said lower mouth divergent tubular elements that are joined to the tubular elements of the upper embouchure, remaining braced by other normal tubular sections to the upper diametrical sections, so that thanks to the semicircular space defined in the central area of the diametrical tubular elements, both bodies can be placed below the aerial mass of the tree, practically embracing the tree trunk, providing an upper embouchure of sufficient amplitude for cover the projection vertical of said aerial mass of the tree, in such a way that, the detached fruit falls inside the two bodies of hopper, which are completed with a coating of tight and tight mesh, so that the fruits collected are poured through the lower discharge mouth to a collecting container.

Another invention is the patent ES2027101, which refers to a vibrating machine for collecting fruits, characterized by consisting of a chassis in the form of a drawer without top cover and whose sides are slightly trapezoidal; this chassis is opened lengthwise, in two equal parts each, attached to a tractor blade by conventional means; in this chassis, the umbrella rods are fixed, which can be bendable and are operated by means of hydraulic cylinders that transmit the movement of the tractor to the mechanism that folds the rods; these rods support a cloth or similar that opens in two halves on the sides of the tractor blades and in the lower part have textile pieces that act as coupling joints; the tank has a gate in the lower base closest to the tractor, with suitable fixing means; the rods are operated hydraulically or manually.

While these patents meet the objective, it is also true that they present certain deficiencies, such as, for example, the first patent, does not have a direct system of transporting the fruit to the packaging and the second patent, has a deficiency because it does not reduce the fruit fall speed, which deteriorates it, another problem is that the bag with fruit reaches down turned into a projectile and accident a worker, does not allow to quantify the harvest.

### DESCRIPTION OF THE FIGURES

To better understand the invention, system for the collection and transport of fruits, from hillsides or slopes or similar, we will describe it based on the figures that form an integral part of this invention, without meaning restricting it to obvious modifications that could arise, where:

FIG. 1 shows a perspective view of the union of the fruit transport system, with a straight upper tubular body and a lower corrugated tubular body, arranged in a curve.

FIG. 2 shows a longitudinal sectional view of the lower curved tubular leather for container retention.

FIG. 3 shows a side view of a container for fruit transport by the tubular transport system of the invention.

### BRIEF DESCRIPTION OF THE INVENTION

System for the collection and transport of fruits, from slopes or slopes of hills or the like, is conformed with a tubular body (1) of PVC, which is anchored to the slope of the hill (2) being detachable, light and portable, characterized in that the straight tubular body (1) is provided with openings (3) each a certain number of meters, so as to introduce into said openings (3), containers with fruit (4), which are provided with projections (5), said openings are arranged so as to correspond to the rows of fruit trees; at the lower end of said tubular body (1), a further corrugated tubular retention body (7) of containers (4) and arranged in a curved, non-collapsible manner is fitted by means of a quick coupling system (6), which makes it possible to reduce the speed of the fruit containers (4), those that go inside the tubular body (1) transporting the fruit inside.

### DETAILED DESCRIPTION OF THE INVENTION

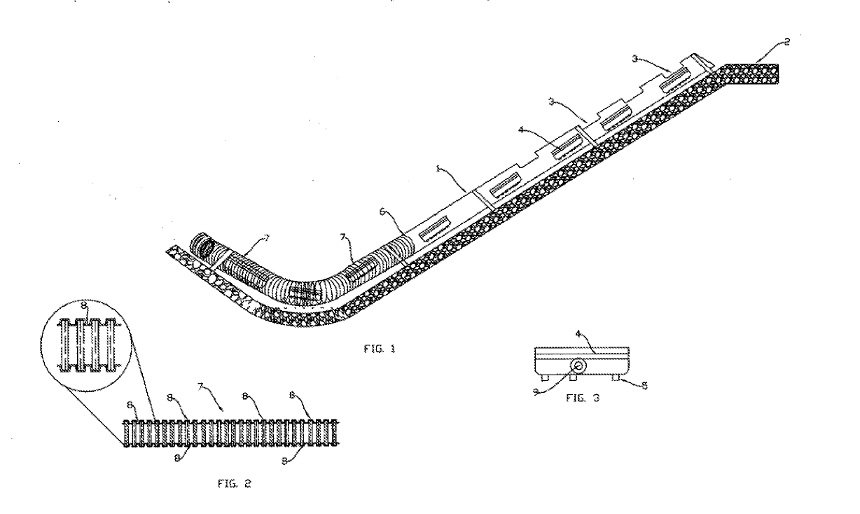

With reference to FIGS. 1 to 3, the invention, system of harvesting and transporting fruit from hillsides or hill slopes or the like, is formed with a tubular body (1) of PVC, which is anchored to the slope of the hill by means of iron forks (2) being detachable, light and portable; provided with openings (3) each a certain number of meters, so as to introduce into these openings (3) containers with fruit (4), which are provided with lower protrusions (5), said openings are arranged (every 6 m) so that they correspond to the row of fruit trees. At the lower end of said tubular body (1), it is coupled by a quick coupling system (6) with a shaped pipe or body tubular retention (7) container (4) and arranged in a curved shape which can vary its angle depending on the level of acceleration of the container, not collapsible, allowing to reduce the speed of fruit containers (4), which they go inside the tubular body (1) transporting the fruit inside.

This system adapts to any type of hillsides and allows to harvest the fruit trees that are planted in it, such as: avocados, olives, vines, prickly pears, lucuma, etc.

The system works by gravity, without internal cables and although the containers (4), which contain the fruit collected on steep slopes, take a great speed on the slope, the corrugated tubular body (7) has outgoing equidistant interior shapes (8) that faced with the protrusions (5) of the containers (4), they allow to brake the containers with fruit (4). This corrugated tube (7) is shorter than the straight tubular body (1) and is arranged with a greater curvature as the system of the invention is installed on a greater slope.

In addition, each container of fruit (4) carries an electronic chip (9) that identifies it, to determine the performance of the fruit harvester.

The chips (9) are monitored from a PC (not illustrated), which allows the owner of the plantation to access the system from where he is and to know at any time the quantity of containers harvested and therefore the volume of his harvest, yield of your staff and build all the statistics that the economic management of the garden requires.

This system is adaptable to different sizes of orchards and absolutely portable, which allows its transfer to the interior of the orchard to the extent that it is harvested and its use in other orchards.

1. Portable system for the collection and transport of fruits from slopes or slopes of hills or similar, it is conformed with a tubular body (1) of PVC, which is anchored to the slope of the hill (2) being dismantled, light and portable, CHARACTERIZED because the straight tubular body (1), is provided with openings (3) each a certain number of meters, so as to introduce into these openings (3), containers with fruit (4), which are provided with projections (5), said openings are arranged (every 6 m) so that they correspond to the rows of fruit trees; at the lower end of said tubular body (1), another corrugated tubular retention body (7) of containers (4) and arranged in a curved, non-collapsible manner is fitted by means of a quick coupling system (6), which makes it possible to reduce the speed of the fruit containers (4), those that go inside the tubular body (1) transporting the fruit inside.

2. Portable system according to claim 1, CHARACTERIZED because the system adapts to any type of hillsides and allows to harvest the fruit trees that are planted in it, such as: orange trees, lemons, avocados, lucuma, etc.

3. Portable system according to claim 1, CHARACTERIZED because the system works by gravity, without internal cables and although the containers (4), which contain the fruit collected on steep slopes, take a great speed in the slope, the corrugated tubular body (7) forms interior equidistant protrusions (8) which, faced with the projections (5) of the containers (4), allow the containers with fruit (4) to be stopped.

4. Portable system according to claim 1, characterized in that the corrugated tubular body (7), is shorter than the straight tubular body (1) and has a greater curvature to the extent that the system of the invention is installed on a greater slope.

5. Portable system to claim 1, CHARACTERIZED because each fruit container (4) carries an electronic chip (9) that allows identifying it, to determine the quantitative yield of fruit harvest; the chips (9) are monitored from a PC.
